(19) United States
(12) Patent Application Publication
(10) Pub. No.: US 2022/0087371 A1
(43) Pub. Date: Mar. 24, 2022

(54) TOUCHLESS RING SYSTEM AND METHOD OF USE

(71) Applicant: Fernando Newcomb, Hong Kong (HK)

(72) Inventor: Fernando Newcomb, Hong Kong (HK)

(21) Appl. No.: 17/479,017

(22) Filed: Sep. 20, 2021

Related U.S. Application Data
(60) Provisional application No. 63/081,375, filed on Sep. 22, 2020.

(51) Int. Cl. A44B 15/00; B67B 7/44

(52) U.S. Cl. CPC A44B 15/007; B67B 7/44

(57) ABSTRACT

A touchless ring system and methods of use are presented. The touchless keychain system with integrated touchless ring feature is designed to solve well-known and long standing problems in the touching surfaces and the spread of diseases. As one solution to this long existing problem and other problems with the spread of disease, the touchless keychain system provides a user with easy access to a touchless ring for opening doors and the like. The disclosure provides a touchless feature which is convenient and easy to use, easy to store, and can interact with various surfaces and features.

### CROSS-REFERENCE TO RELATED APPLICATIONS:

The present application claims priority to the U.S. Provisional Patent Application No. 63/081,375 which was filed on Sep. 22, 2020, which is hereby incorporated by reference herein in its entirety, including any figures, tables, or drawings.

### FIELD OF THE DISCLOSURE:

The present disclosure relates generally to a touchless keychain system and method of use. More specifically, and without limitation, the present disclosure relates to a personal touchless safety system with integrated features, grabbing and pressing features and components. More specifically, and without limitation, the present disclosure relates to a convenient to access touchless ring with an integrated touchless safety device, and other devices, features, and components. However, the present disclosure is not limited to these novel and inventive systems and improvements and methods of use, and it may further be adapted for a variety of purposes.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright Sentinel Systems Limited. All rights reserved.

### BACKGROUND OF THE DISCLOSURE:

The present disclosure relates generally to a touchless keychain system. More specifically, and without limitation, the present disclosure relates to a personal touchless safety system with integrated assistance, grabbing and pressing features and components. More specifically, and without limitation, the present disclosure relates to a convenient carry case system with an integrated touchless safety device, and other devices, features, and components. However, the present disclosure is not limited to these novel and inventive systems and improvements and methods of use, and it may further be adapted for a variety of purposes.

Bacteria and/or germs are well known in the art. While sometimes bacteria is helpful to human wellbeing, oftentimes the presence of certain types of bacteria can be detrimental to human health and wellbeing. Bacteria can cause infections and disease in humans. Some examples of such bacteria, such as flesh eating bacteria, affect the soft tissue of a human surrounding muscles, nerves, blood vessels, and more. Other bacteria can be dangerous for those with lower immunology and the like. Bacteria live on surfaces, for varying times, and can inhabit just about any surface.

Viruses are also well known in the art. Viruses vary greatly in type and human effect. Some viruses are commonly shaken off by the human immune system such as the common cold. Other viruses such as influenza or coronavirus may not be so easily deterred. A virus is a sub-microscopic infective agent that replicates inside a host, oftentimes a human host. More than 6,000 viruses have been identified and described in detail; while millions of viruses exist and inhabit nearly every surface. Viruses

Just as the number of virus types in existence today is numerous, the number of spreading means for a virus are also numerous. Transmission of a virus, also known as a “pathway”, is through a disease bearing organism. An example of such a disease bearing organism is a human. A human can spread a virus to another human through proximity, transfer of fluids, and the like. For example, influenza viruses are spread by coughing and sneezing, from human to human. In other words, if a human coughs and/or sneezes, a number of droplets, moisture droplets, are released into the air in the space around the disease bearing human. These droplets, unseen, can land on another human where the virus is inhaled, absorbed through skin, and the like. Additionally, and in a like transmission, the virus may land on a door handle, on an elevator button, on a checkout pad at a grocery store, on a chair back, or another surface which humans interact with, to cause the spread of the virus.

It is nearly impossible for a human to move about their environment without being exposed to viruses, bacteria, and the like. For example, a trip to the grocery store may seem simple or short, especially to those living in an urban setting. However, leaving one's apartment may require use of an elevator and interaction with a number of buttons which might have been used by disease bearing individuals. Furthermore, a door handle may be required to open a door to enter the grocery store. Furthermore, the checkout at the grocery store likely requires a pin code to be entered to complete the transaction. Finally the return trip home presents like opportunities. For this reason, a simple trip outside may present hundreds of opportunities for infection.

For these reasons, and more, there exists a need in the art for a convenient touchless ring assistant; not only to protect the user but to slow the spread of viruses and disease. Some such tools do exist in the art, even using a car key or fob to press an elevator button. However, these tools or uses lack convenience. Many humans do not own a car, carry car keys, or the like. For this reason there exists a need in the art for a convenient tool which is easily accessible but that can also be easily hidden away when not in use so as to limit clutter and taking up space in a person's pocket or purse, or the like.

Furthermore, there exist some items which a user may use as tools to avoid touching or coming into direct contact with a surface. These items, such as a house key or car fob are commonly tucked into a pocket or purse after use. The contaminants are then spread to clothing fabric and other items in the purse. Thus, there exists a need in the art for a tool that can be stored away after use to prevent spread of contaminants.

Thus, there is a need in the art for a more sophisticated, accessible touchless safety device. The art is in need of a more improved, flexible, convenient, and slender device, which not only provides for enhanced purpose and use in preventing the spread of disease, viruses, bacteria, and the like, but also provides an ease for storing and retrieving functions when the item is needed or isn't needed. Additionally, there exists a long-felt need in the art for a more improved touchless safety device.

The present disclosure solves these problems as well as a host of other problems with modern sanitary devices. The present disclosure combines unique physics with innovative design to achieve these goals which are long-felt in the state of the art and more. Thus, it is a primary objective of the present disclosure to provide a lightweight, comfortable, convenient touchless safety device capable of holding its position, capable of sleek integration with a key chain, key ring, keys, and other items, and the like; and also capable of achieving physics ease for opening and manipulation of the device with surroundings. Furthermore, it is the primary object of this disclosure to provide a touchless key ring device with a plurality of features that provide convenience and support while engaging in movement activities from opening doors, to pressing buttons, to signing signature pads, to opening bottles, to handing a device to another person, and more.

Furthermore, it is a primary objective to provide a touchless safety and disease prevention device that provides demonstrated physics and physics usage to create a more stable, safe, and easy to use design. This is a complex challenge that the present disclosure provides solutions to which include convenience and hiding the device when not in use. Thus, it is a primary object of the disclosure to provide a touchless safety device that is comfortable, strong, easy to use, is aesthetically pleasing, is functional, reusable, convenient, sleek, safe, and more. The present disclosure is directed toward providing these solutions and more.

The disclosure herein provides these advantages and others as will become clear from the specification and claims provided.

### SUMMARY OF THE DISCLOSURE

The purpose of this disclosure is to provide the state of the art with a touchless keychain system which provides for increased functionality, flexibility, safety, and more. Said another way, the purpose of this disclosure is to provide a touchless keychain and disease prevention device that provides demonstrated physics and physics usage to create a more stable, safe, and easy to use design. This is a complex challenge that the present disclosure provides solutions to which include convenience and hiding the device when not in use. Additionally, the purpose of the present disclosure is to provide the state of the art with an antimicrobial material integrated into the design of a touchless keychain. Thus, it is a primary object of the disclosure to provide a touchless safety device that is comfortable, strong, easy to use, is aesthetically pleasing, is functional, reusable, convenient, sleek, safe, and more. The present disclosure is directed toward providing these solutions and more.

Furthermore, it is the primary object of this disclosure to provide a touchless key device with integrated antimicrobial characteristics. The touchless keychain provides touchless handling and support while moving around spaces, conducting daily activities, engaging with other humans and other spaces, and the like. Furthermore, it is a primary objective to provide demonstrated physics and physics usage to create a more stable, safe, and easy to use design when having an integrated touchless safety device.

This complex challenge and others are solutions the present disclosure solves. Thus, it is a primary object of the disclosure to provide a touchless device that is convenient, comfortable, stable, provides ease of access, ease of storage, is aesthetically pleasing, is functional, reusable, easy to use, safe, and easy to store. The present disclosure is directed toward providing these solutions and more.

In combination with convenience, appearance, ease of use, enhanced method of use, longevity for lack of reduction of the supporting materials, the present disclosure offers a health solution and mechanics solution, along with innovations to those existing in the art. Many long-felt needs in the art, which prevents a user, needing or wanting an access device and the ability to touch checkout stands, open doors, and the like without exposing themselves and/or others to disease, but not using a device due to a lack of functionality, appearance, choice, stability, trust, and loss of appearance qualities of existing touchless rings such as storage and a lack of ease of access. Furthermore, the present disclosure provides a mass producible solution to providing a relatively affordable mobility option within the intuitive range of touchless devices, along with the other features and components herein.

Through a solution that incorporates convenience, health, ergonomic comfort, overall comfort, overall health, injury prevention, stabilization advantages and more, along with functionality advantages, as well as proper deployment, the disclosure herein presents a much improved, novel, and needed touchless ring safety device solution.

Thus, it is a primary object of the disclosure to provide a touchless keychain system and method of use that improves upon the state of the art.

Another object of the disclosure is to provide a touchless keychain system and method of use that is easy to use.

Yet another object of the disclosure is to provide a touchless keychain system and method of use that is stable for a user.

Another object of the disclosure is to provide a touchless keychain system and method of use that is easy to access.

Yet another object of the disclosure is to provide a touchless keychain system and method of use that is convenient to store.

Another object of the disclosure is to provide a touchless keychain system and method of use that is easy to store.

Another object of the disclosure is to provide a touchless keychain system and method of use that is quick and efficient.

Yet another object of the disclosure is to provide a touchless keychain system and method of use that provides suitable support for a user.

Another object of the disclosure is to provide a touchless keychain system and method of use that allows a user to open a door without touching a door handle or other surface.

Yet another object of the disclosure is to provide a touchless keychain system and method of use that allows for a user to control an elevator without touching the elevator button or other surface.

Another object of the disclosure is to provide a touchless keychain system and method of use that allows a user to press a pin pad without touching the pin pad or other surface.

Yet another object of the disclosure is to provide a touchless keychain system and method of use that provides a means for a user to sign a signature without touching a pen or signature pad.

Another object of the disclosure is to provide a touchless keychain system and method of use that provides a plurality of various features.

Yet another object of the disclosure is to provide a touchless keychain system and method of use that provides a bottle opener and/or can opener.

Another object of the disclosure is to provide a touchless keychain system and method of use that provides a plurality of different functional components.

Yet another object of the disclosure is to provide a touchless keychain system and method of use that provides a means for a user to move about and through spaces without coming into direct contact with a surface.

Another object of the disclosure is to provide a touchless keychain system and method of use that provides a unique angle which aids in the physics of operation.

Yet another object of the disclosure is to provide a touchless keychain system and method of use that handles various door types with ease.

Yet another object of the disclosure is to provide a touchless keychain system and method of use that aids a variety of users.

Another object of the disclosure is to provide a touchless keychain system and method of use that addresses long-felt needs in the art.

Yet another object of the disclosure is to provide a touchless keychain system and method of use that is intuitive.

Another object of the disclosure is to provide a touchless keychain system and method of use that is simple.

Yet another object of the disclosure is to provide a touchless keychain system and method of use that is portable.

Another object of the disclosure is to provide a touchless keychain system and method of use that is accessible.

Yet another object of the disclosure is to provide a touchless keychain system and method of use that is universal.

Another object of the disclosure is to provide a touchless keychain system and method of use that is adaptable.

Yet another object of the disclosure is to provide a touchless keychain system and method of use that is modular.

Another object of the disclosure is to provide a touchless keychain system and method of use that is sleek.

Yet another object of the disclosure is to provide a touchless keychain system and method of use that is aesthetically pleasing.

Another object of the disclosure is to provide a touchless keychain system and method of use that is user friendly.

Yet another object of the disclosure is to provide a touchless keychain system and method of use that is lightweight.

Another object of the disclosure is to provide a touchless keychain system and method of use that is stable against vertical, horizontal forces, and/or any combination thereof.

Yet another object of the disclosure is to provide a touchless keychain system and method of use that is easy to handle.

Another object of the disclosure is to provide a touchless keychain system and method of use that is retractable.

Yet another object of the disclosure is to provide a touchless keychain system and method of use that is spring loaded.

Another object of the disclosure is to provide a touchless keychain system and method of use that locks in place.

Yet another object of the disclosure is to provide a touchless keychain system and method of use that provides for multiple positions.

Another object of the disclosure is to provide a personal touchless keychain system and method of use that provides an optimal angle of orientation.

Yet another object of the disclosure is to provide a touchless keychain system and method of use that includes anti-slip features.

Another object of the disclosure is to provide a touchless keychain system and method of use that is robust.

Yet another object of the disclosure is to provide a touchless keychain system and method of use that is safe.

Another object of the disclosure is to provide a touchless keychain system and method of use that tracks usage data.

Yet another object of the disclosure is to provide a touchless keychain system and method of use that is coated with an anti-bacterial and/or antimicrobial.

Another object of the disclosure is to provide a touchless keychain system and method of use that tracks historical usage data.

Yet another object of the disclosure is to provide a personal touchless keychain system and method of use that is made of a material which is virus resistant.

Another object of the disclosure is to provide a touchless keychain system and method of use that is made of a conductive alloy.

Another object of the disclosure is to provide a touchless keychain system and method of use that is made of metal.

Yet another object of the disclosure is to provide a touchless keychain system and method of use that is made of a polymer.

Another object of the disclosure is to provide a touchless keychain system and method of use that is made of an enhanced polymer.

Yet another object of the disclosure is to provide a touchless keychain system and method of use that has a unitary construction.

Another object of the disclosure is to provide a touchless keychain system and method of use that integrates an antimicrobial material.

Yet another object of the disclosure is to provide a touchless keychain system and method of use that is made from an antimicrobial material.

Another object of the disclosure is to provide a touchless keychain system and method of use that is infused with an antimicrobial material.

These and other objects, features, or advantages of the present disclosure will become apparent from the specification and claims.

### BRIEF DESCRIPTION OF THE DRAWINGS:

FIG. 1 is a top, perspective view showing the touchless keychain system; the view showing the touchless keychain system in a closed position; the view showing the main body; the view showing the interior clip; the interior clip in the closed position; the view showing the extension feature; the view showing the extension feature in the closed position; the view showing the extension control feature.

FIG. 2 is a side, elevation view showing the touchless keychain system; the view showing the touchless keychain system in a closed position; the view showing the main body; the view showing the interior clip; the interior clip in the closed position; the view showing the extension feature; the view showing the extension feature in the closed position; the view showing the extension control feature.

FIG. 3 is a front, elevation view showing the touchless keychain system; the view showing the touchless keychain system in a closed position; the view showing the main body; the view showing the interior clip; the interior clip in the closed position; the view showing the extension feature; the view showing the extension feature in the closed position.

FIG. 4 is a rear elevation view showing the touchless keychain system; the view showing the touchless keychain system in a closed position; the view showing the main body; the view showing the interior clip; the interior clip in the closed position; the view showing the extension control feature.

FIG. 5 is a top view showing the touchless keychain system; the view showing the touchless keychain system in a closed position; the view showing the main body; the view showing the interior clip; the interior clip in the closed position; the view showing the extension feature; the view showing the extension feature in the closed position; the view showing the extension control feature.

FIG. 6 is a bottom view showing the touchless keychain system; the view showing the touchless keychain system in a closed position; the view showing the main body; the view showing the interior clip; the interior clip in the closed position; the view showing the extension feature; the view showing the extension feature in the closed position; the view showing the extension control feature.

FIG. 7 is a side, elevation view showing the touchless keychain system; the view showing the touchless keychain system in a closed position; the view showing the main body; the view showing the interior clip; the interior clip in the closed position; the view showing the extension feature; the view showing the extension feature in the closed position; the view showing the extension control feature.

FIG. 8 is a rear, top, perspective view showing the touchless keychain system; the view showing the touchless keychain system in a closed position; the view showing the main body; the view showing the interior clip; the interior clip in the closed position; the view showing the extension feature; the view showing the extension feature in the closed position; the view showing the extension control feature; the view showing the extension control feature in the open position.

FIG. 9 is a rear, top, perspective view showing the touchless keychain system; the view showing the touchless keychain system in a closed position; the view showing the main body; the view showing the interior clip; the interior clip in the closed position; the view showing the extension feature; the view showing the extension feature in the closed position; the view showing the extension control feature; the view showing the extension control feature in the open position; the view showing a ring attached to the touchless keychain system.

FIG. 10 is a top, perspective view showing the touchless keychain system; the view showing the touchless keychain system in a closed position; the view showing the main body; the view showing the interior clip; the interior clip in the open position; the view showing the extension feature; the view showing the extension feature in the closed position; the view showing the extension control feature; the view showing the extension control feature in the open position.

FIG. 11 is a top, perspective view showing the touchless keychain system; the view showing the touchless keychain system in a closed position; the view showing the main body; the view showing the interior clip; the interior clip in the closed position; the view showing the extension feature; the view showing the extension feature in the open position; the view showing the extension control feature; the view showing the extension control feature in the closed position.

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

All illustrations of the drawings are for the purpose of describing selected versions of the present disclosure and are not intended to limit the scope of the present disclosure.

Although the disclosure has been explained in relation to its preferred embodiment, it is to be understood that many other possible modifications and variations can be made without departing from the spirit and scope of the disclosure.

With reference to the figures, a touchless keychain system and methods of use is presented. The touchless keychain system with integrated touchless ring feature is designed to solve well-known and long standing problems in the touching surfaces and the spread of diseases. As one solution to this long existing problem and other problems with the spread of disease, the touchless keychain system provides a user with easy access to a touchless ring for opening doors and the like.

The touchless keychain system with integrated touchless ring is not bulky and does not hinder the ability of a user to store and/or access the tool itself. The tool is convenient and pops out of a key ring and/or key chain, which is slender. In this way the tool is always accessible and ready for a user.

These long felt needs, other functionality, and additional features are some of the features presented herein with the touchless keychain system with a plurality of features. These features, taken alone as personal case feature, as a plurality of innovations to a touchless keychain system, and a plurality of novel designs which changes the state of the art and make using touchless ring system which is comfortable, ergonomic, safe, easy, fun, and efficient. These features, other features, and a combination of these features will become more apparent from the description of the specification, claims, and other information presented herein.

Said another way, the system presented herein, is a touchless keychain system that integrates a touchless ring with a key chain, or the like.

System

With reference to the figures, a personal case system with a touchless keychain system 10 (or “touchless ring”, or “keychain tool system”, or “touchless ring system”, or simply “system”), and methods of use are presented herein. touchless ring system 10 is formed of any suitable size, shape and design and is configured as an easy to use, convenient to access touchless ring. Said another way, system 10 is configured to provide convenient access to an antimicrobial infused device which can quickly snap into a touchless ring position from a keychain and or ring. Furthermore, system 10 can be quickly closed for storage and the like.

In this way, the system 10 provides for regular and convenient access to a touchless ring. In this way, a user will have access to a touchless ring whenever that user has the system 10 and/or has the keychain with them. The keychain can be quickly opened and quickly closed. The integrated touchless ring is easy to access and store within the system 10; maximizing convenience for storage and encouraging use of the system. In the arrangement shown, as one example, system 10 is configured as a key ring and can easily attach to a user's keys and/or other accessories.

Said another way, the key ring system 10 provides an aesthetically pleasing, easy to use touchless ring device. The flexibility of the system not only allows a user to be comfortable—having peace of mind—but also comfortable with an ergonomic handling device for handling daily tasks without coming into direct contact with a plurality of surfaces—and stabilized in the handling of the key chain device—while providing ergonomic support and stability throughout the entire process. At these times, where the spread of disease affects the daily life of humans around the world, a touchless system which aids in the prevention of the spread of disease is more critical than ever.

In the arrangement shown, as one example, touchless key chain system 10 includes a main body 20, an interior clip feature 30, and an extension feature 40, among other components, features, systems, and functions. Additionally, the system 10 may also include a user, a surface 14 or plurality of surfaces 14, a key chain 16, and a key ring 18, among other components features, systems, and functions.

User: In the arrangement shown, as one example, the touchless system 10 is formed to generally be handled by a single user at a given time. User is typically a single person. In this way, a user is any human engaging with the system 10. Furthermore, in the arrangement shown, as one example, the user may be using the system 10 to interact with a surface or exterior component, and/or a user may be utilizing system 10 as a device to hold key chains and/or key rings together while organizing keys or other features such as vehicle fobs and/or other devices carried or stored on small rings.

Surface: In the arrangement shown, as one example, the touchless keychain system 10 is formed to help with daily interactions and provide a means so that a user does not have to come into direct contact with a plurality of surfaces. A surface 14 is formed of any suitable size, shape, and design and may be a door handle, may be a countertop, may be an elevator button, may be a point of sale system, may be a grocery bag, may be a pin pad, may be a car door handle, may be a shopping cart, may be a doorbell, may be an electronic device such as a cell phone or other smart device with a touch screen, and the like, and/or any combination of these items, and/or any other surface a user wishes to engage in.

Main Body:

In the arrangement shown, as one example, system 10 includes a main body 20. Main body 20 (or “ring”, or “case”, or simply “body”) is formed of any suitable size, shape, and design and is configured as the main portion of the device for the touchless ring, for the handle, for the holster, and for the storage of all the components and features. The case 20 is configured to hold, and in one embodiment, completely conceal the touchless ring, among other components within the primary housing of the main body. Furthermore, and said another way, main body 20 is the main interaction system and primary structure of system 10.

In the arrangement shown, as one example, main body 20 is also configured to connect to a keychain and/or key ring. Additionally, and in the arrangement shown, main body 20 is configured to quickly connect to and/or quickly accept a variety of other devices which can be connected such as a key chain, key ring, keys, car fobs, belt loops, carabiners, lanyards, any combination thereof, and the like.

In the arrangement shown, as one example, the main body 20 is formed in the shape of a ring and generally appears as a circle, when viewed from the side. When viewed from the front, the ring is slender. In the arrangement shown, as one example, the ring of the main body 20 is configured to fit within the palm of the hand of a user. However, other sizes for the ring are also contemplated for use, such as a ring that can accommodate the palm of a hand fitting through the interior, and/or to be worn as a bracelet and the like.

A key ring, also known as a key chain, is a commonly known device in the art. Key rings and/or key chains provide organization to and/or a structural system which links a plurality of keychains or other devices capable of being attached to a ring and/or tethered.

In the arrangement shown, as one example, the main body 20, being formed in the shape of a ring, provides for convenience. In this way, a user can always have the touchless ring conveniently at their fingertips and ready because the user will likely have the car keys and/or items operably attached to system 10. Furthermore, in the arrangement shown, as one example, system 10 is designed to be handled with a single hand. Two hands are not required for operation. In other words, and in the embodiment shown, whenever the user has their keys and/or keychain, the user will have system 10 with them and ready to use.

In the arrangement shown, as one example, the main body 20 generally takes the same shape and size as a ring which can fit within the palm of the hand of the user. In the arrangement shown, as one example, a circular ring which works as a key chain is hereby contemplated for use. However, other forms of main body 20 are hereby contemplated for use. Examples of other forms of a main body 20 includes, but are not limited to, a standalone ring which does not connect to a key chain and/or does not provide access to allow additional rings to be connected thereto—wherein the standalone ring may be a square shape, an elliptical shape, a spherical shape, and the like—the main body 20 may also be in the shape so as to attach to a to-go coffee mug and/or to go water bottle, a tablet, a smart watch, a watch, a wrist band, and other items, and the like.

Additionally, and in the arrangement shown, as one example, main body 20 is formed of a unitary construction. However, other constructions, such as a dual piece construction with snap fittings are hereby contemplated for use, along with other constructions and connections such as hinged connects, and more. In this way, a user can place their device within the main body 20 and snap the two pieces together, three pieces together, four pieces together, five pieces together, six pieces together, or more, to enclose the device. This construction means and more are hereby contemplated for use.

Additionally, and in the arrangement shown, as one example, main body 20 is formed of a metal material. The metal material is rigid but provides for some flexibility. Other materials are also hereby contemplated for use such as polymers, enhanced polymers, metals, brass, copper, silver, gold, other metal alloys, carbon fiber, polyvinyl chloride, any combination thereof, and the like. In this way, materials can provide decorative and functional purposes from waterproofing to appearance and durability, and the like. Additionally, and in this way, design can be enhanced for appearance and functionality. These types of appearance changes are hereby contemplated for use which may aid in functionality. In the arrangement shown, as one example, the main body 20 is formed of an antimicrobial material and/or infused with an antimicrobial material so as to repel and/or prevent and/or kill infectious diseases.

In the arrangement shown, as one example, the main body 20 has an exterior surface 22, an interior surface 24, opposing sides 25, a hollow interior 26, a plurality of cavities 27, a holster 28 of the plurality of cavities 27, and a plurality of attachment features 29, among other components, features, and the like.

Holster: In the arrangement shown, as one example, main body 20 includes a plurality of cavities 27. One of the plurality of cavities 27 is at least one holster 36. Holster 36 (or “insert”, or “pocket”, or “receptacle”, or “touchless ring pocket”) is formed from the opposing sidewalls of the main body 20. Holster 28, is a hollow portion of the main body 20 which provides enough space for the slender touchless ring to slide in and out of—and in the arrangement shown, as one example, fit within close and tight tolerances of the hollow interior portion of the holster 28. In addition, the holster 28 may include an attachment feature 29.

Attachment feature: In the arrangement shown, as one example, the holster 36 includes an attachment feature 29. Attachment feature 29 is formed of any suitable size, shape and design and is configured to attach the touchless ring to the main body 20 in a way that the touchless ring is easily accessible. In the arrangement shown, as one example, the attachment feature 29 is formed of a pin which allows the touchless ring to rotate in and out of the holster 28. In this way, the attachment feature provides a stable rotation of the touchless ring so that the touchless ring can be easily rotated out of the holster 28, used for the touchless ring purpose, and then easily rotated back into the interior of the holster 28.

In the arrangement shown, as one example, holster 28 includes an attachment feature 29 which is formed of a pin and a rotationally allowable connection or plurality of connections. However, other attachment means are hereby contemplated for use. Other attachment means may include, but are not limited to, snap features, frictional fit, hinged connections, a combination thereof, and the like. Additionally, a unitary construction is also hereby contemplated for use for an attachment means.

Interior Clip:

In the arrangement shown, as one example, system 10 includes an interior clip 30. Interior clip 30 (or “Access door”, or “access clip”, or “opener valve”, or simply “clip”) is formed of any suitable size, shape, and design and is configured to act as a gate allowing access to the interior of the main body 20. Said another way, and in the arrangement shown, the interior clip 30 is configured to rotate open and spring shut when opening is not needed. In this way, and in the example shown, a second ring or key chain, or key ring can easily be attached and secured into place with the main body 20 by means of the interior clip 30.

In the arrangement shown, as one example, the interior clip 30 is semicircular in shape and completes a portion of the circle which makes up the construction of the main body 20. In the arrangement shown, as one example, the interior clip 30 is formed of the same material as the main body 20. However, the interior clip 30 may also be formed of a different material than the main body 20.

In the arrangement shown, as one example, the interior clip 30 extends from a first end 32—where the interior clip 30 is connected to the main body 20—to a second end 34. Like the main body 20, the interior clip 30 has an interior surface 36, which faces toward the interior portion of the ring. The interior clip 30 also includes an exterior surface 37.

Additionally, and in the arrangement shown, as one example, the interior clip 30 includes at least one attachment feature 38. Attachment feature 38 is formed of any suitable size, shape and design and is configured to attach the interior clip 30 to the main body 20 in a way that the interior and ring functionality of the system is easily accessible. In the arrangement shown, as one example, the attachment feature 38 of the interior clip 30 is formed of a pin which allows the interior clip 30 to rotate in and out of the interior of the main body 20. In this way, the attachment feature provides a stable rotation of the interior clip 30.

In the arrangement shown, as one example, the interior clip 30 also includes a second end which has a clasp feature 39. Clasp feature 39 is formed of any suitable size shape and design and is configured to lock and/or clasp the interior clip 30 in place with the main body 20. In this way, the clasp feature 39 can also lock in place. These and other features, are hereby contemplated for use, among other functionality, and features.

Extension Feature:

In the arrangement shown, as one example, the system 10 includes an extension feature 40. Extension feature 40 (or “extension ring feature”, or “extension”, “or “touchless ring” or simply “tool”) is formed of any suitable size, shape, and design and is configured as an extension arm which folds out of the main body and/or which extends from one of the plurality of cavities of the main body 20.

In the arrangement shown, as one example, extension feature 40 extends from a first end 42 to a second end 44 having an interior surface 46 and an exterior surface 48. The touchless ring and/or extension feature 40 which extends from the main body 20 much like the shape of the finger of a human finger or curved structure in a way that enables the user to engage with surfaces like a user would engage surface with the touch of a finger tip and or hand which commonly is used to interact with surfaces.

Additionally, and in the arrangement shown, as one example, the extension feature 40 includes an attachment feature 50, a clasp feature 52, a control knob 54, a stylus 56, a stylus pad 58, and a grab feature 60.

In the arrangement shown, as one example, the extension feature 40 includes at least one attachment feature 50. Attachment feature 50 is formed of any suitable size, shape and design and is configured to attach the extension feature 40 to the main body 20 in a way that the extension feature and ring functionality of the system is easily accessible. In the arrangement shown, as one example, the attachment feature 50 of the extension feature 40 is formed of a pin which allows the extension feature 40 to rotate in and out of the interior of the main body 20. In this way, the attachment feature provides a stable rotation of the extension feature 40.

In the arrangement shown, as one example, extension feature 40 includes a grab feature 60. Grab feature 60 is formed of any suitable size, shape, and design and is configured to allow a user to pull an item directly toward them and/or in a direction. In the arrangement shown, as one example, the grab feature 60 extends from the main body 20 when the extension feature 40 is engaged.

In the arrangement shown, as one example, the extension feature 40 extends from the grab feature at approximately 90 degrees, at the base of the extension feature 40. However, other angles for optimized physics are hereby contemplated for use. Other angles include, but are not limited to, an extension angle of 90 degrees, 0-5 degrees, 5-15 degrees, 15-25 degrees, 25-35 degrees, 35-45 degrees, 45-55 degrees, an incline angle of 55-60 degrees, an incline angle of 60-65 degrees, an incline angle of 65-70 degrees, an incline angle of 80-85 degrees, an incline angle of 85-90 degrees, and the like. Other side to side angles of orientation are also hereby contemplated for use.

Additionally, and in the arrangement shown as one example, the touchless ring includes a single extension touch feature and a single grab feature. However, other numbers of touch features and grab features are hereby contemplated for users. Other numbers of touch features may include a single touch feature, two touch features, three touch features, four touch features, or more. Other numbers of grab features may include a single grab feature, two grab features, three grab features, and more grab features.

Additionally, and in the arrangement shown extension feature 40 is formed of a metal material. The metal material is rigid but provides for some flexibility. Other materials are also hereby contemplated for use such as polymers, enhanced polymers, metals, brass, copper, silver, gold, other metal alloys, carbon fiber, polyvinyl chloride, any combination thereof, and the like. In this way, materials can provide decorative and functional purposes from waterproofing to appearance and durability, and the like. Additionally, and in this way, design can be enhanced for appearance and functionality. These type of appearance changes are hereby contemplated for use which may aid in functionality. In the arrangement shown, as one example, the extension feature 40 is formed of an antimicrobial material and/or infused with an antimicrobial material so as to repel and/or prevent and/or kill infectious diseases.

Antimicrobial Infused System: In the arrangement shown, as one example, system 10 is formed of an antimicrobial material 80. Antimicrobial material 80 may be formed of any suitable mixture, contents, and/or formula and is formed of an antimicrobial infusement. In this way, the material 80 which makes up system 10 is infused with an agent that kills microorganisms and/or stops microorganism growth. Furthermore, in this way, the infused silicone prevents bacterial growth and/or other growth that leads to unhealthy use and/or the spread of infectious disease.

In the arrangement shown, as one example, the infusion of brass acts as an antimicrobial agent. However, other antimicrobial agents are hereby contemplated for use. Other antimicrobial agents, include, but are not limited to, antibiotics, antifungals, penicillin, aminoglycosides, ofloxacin, erythromycin, tetracycline, chloramphenicol, gold, copper, other metals, a combination thereof, and the like.

### Alternative Embodiments/Additional Features

In the arrangement shown, as one example, a plurality of additional features are also hereby contemplated for use.

Bottle Opener:

In an alternative embodiment, the main body 20 may include a bottle opener. Bottle opener is formed of any suitable size, shape, and design and is configured to open bottles and/or other bottles through a prying motion. Bottle openers are well known in the art and are hereby contemplated for use for integration into the system in the main body 20 and/or the extension feature 40.

Locking Mechanism:

In an alternative embodiment, the main body 20 and/or the extension feature 40 may include a locking mechanism.

### Alternative Embodiment

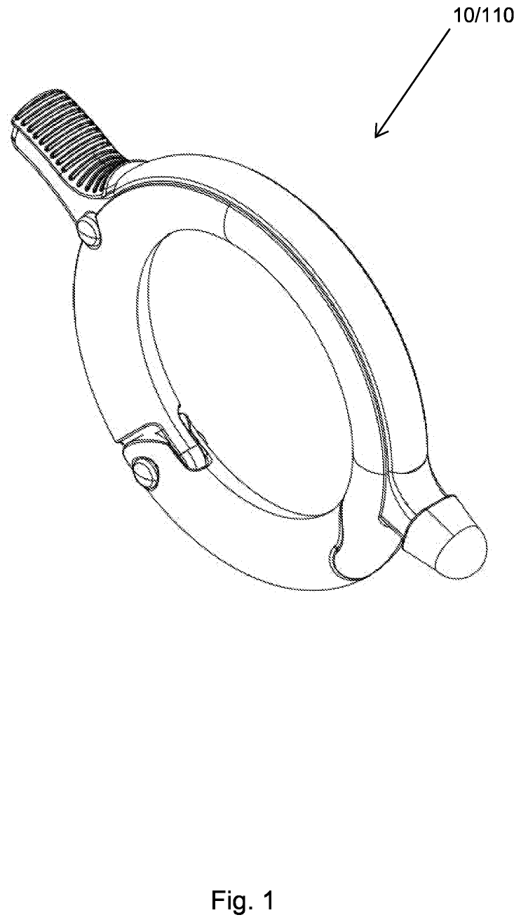

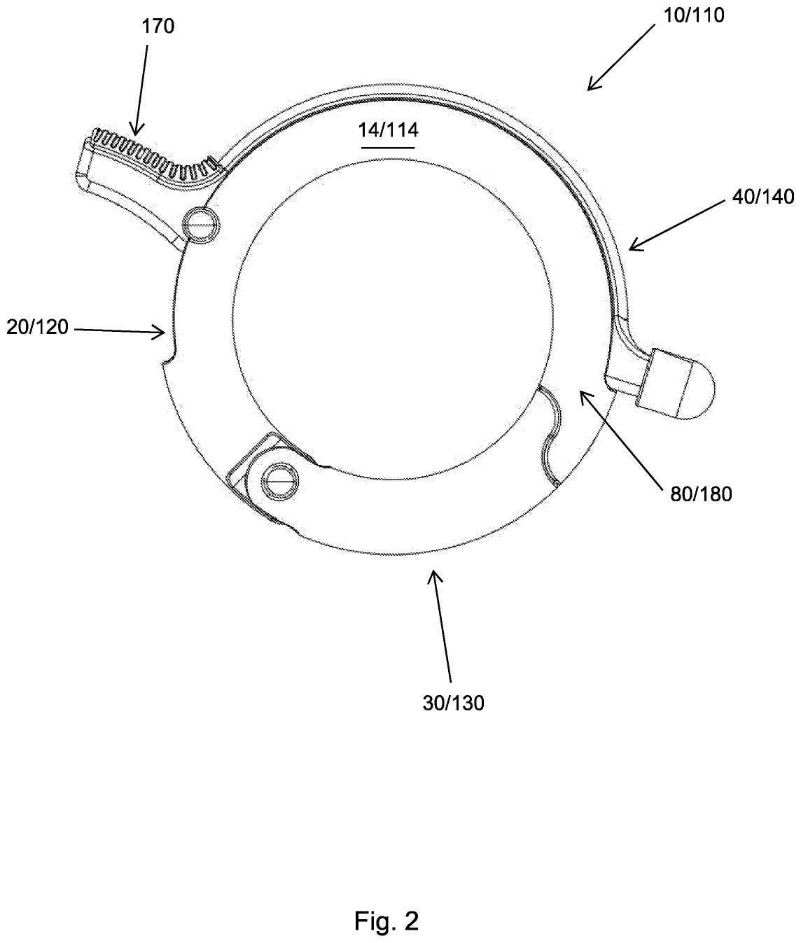

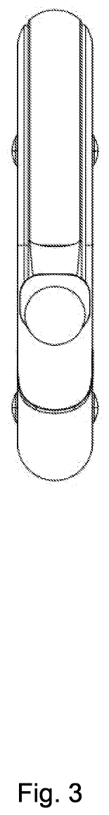

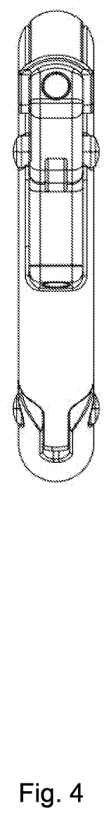

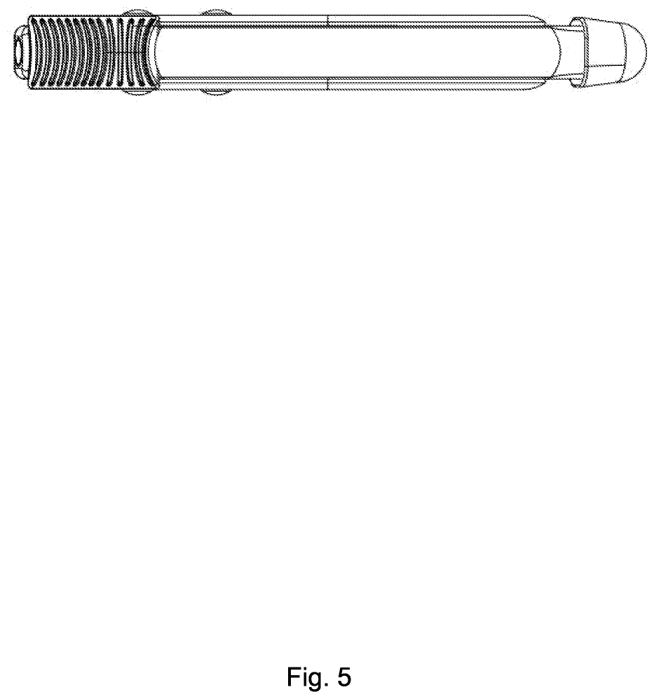

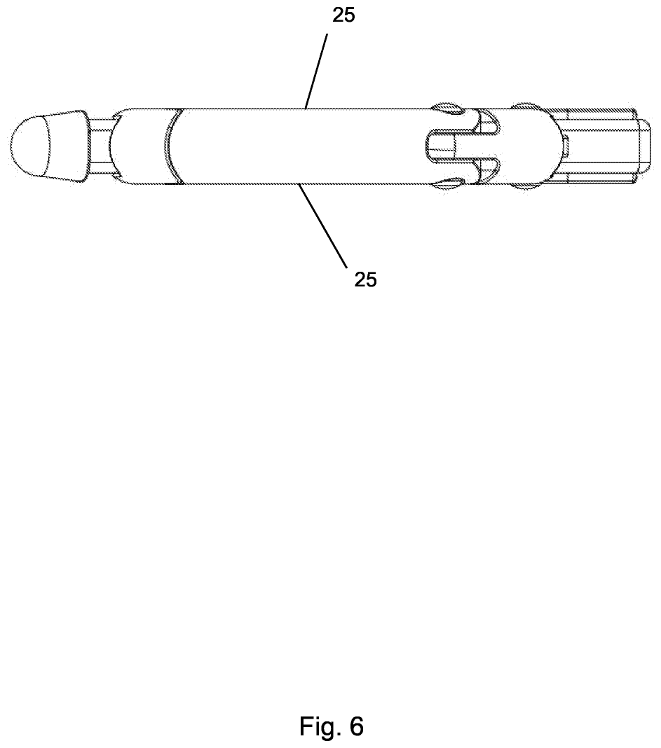

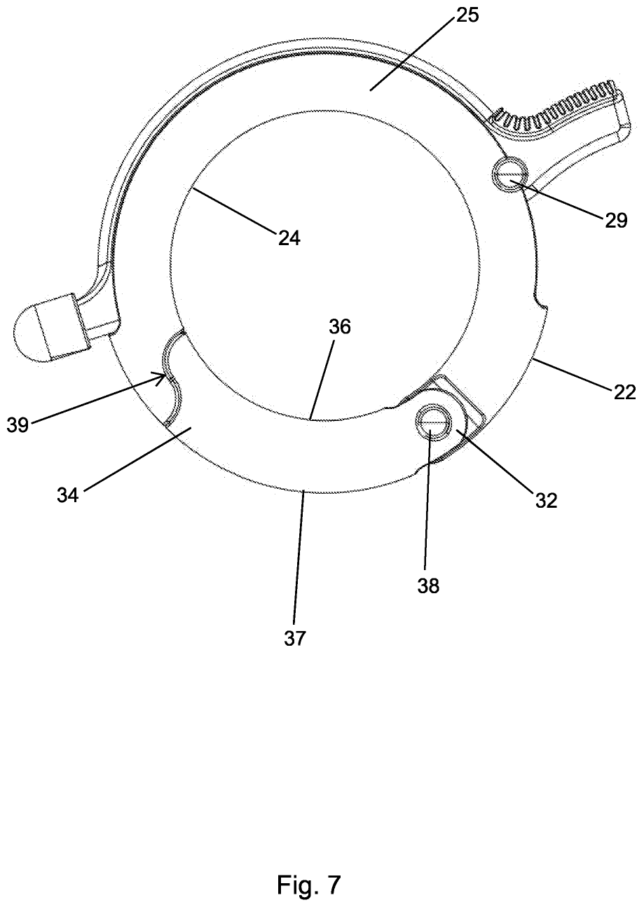

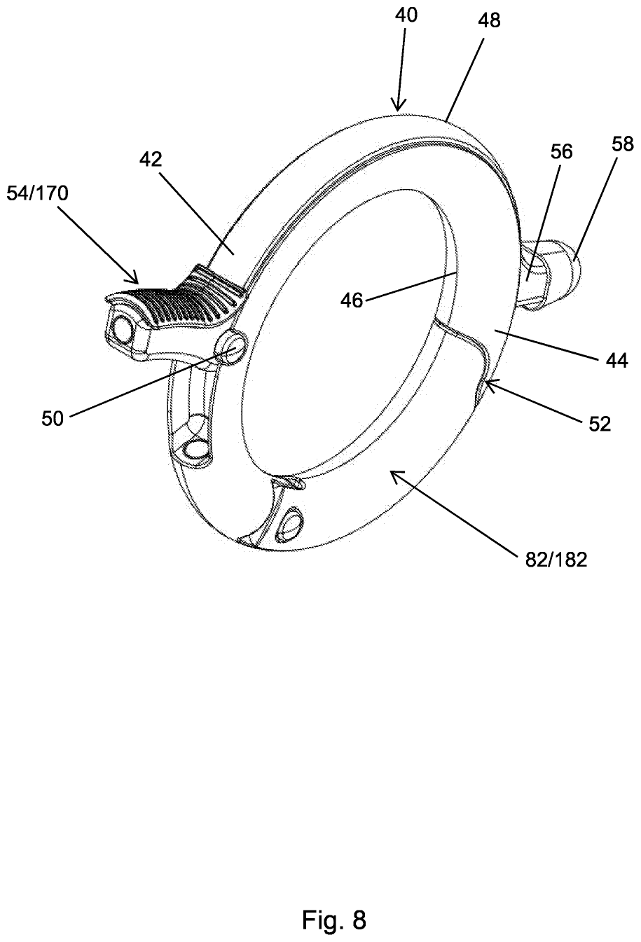

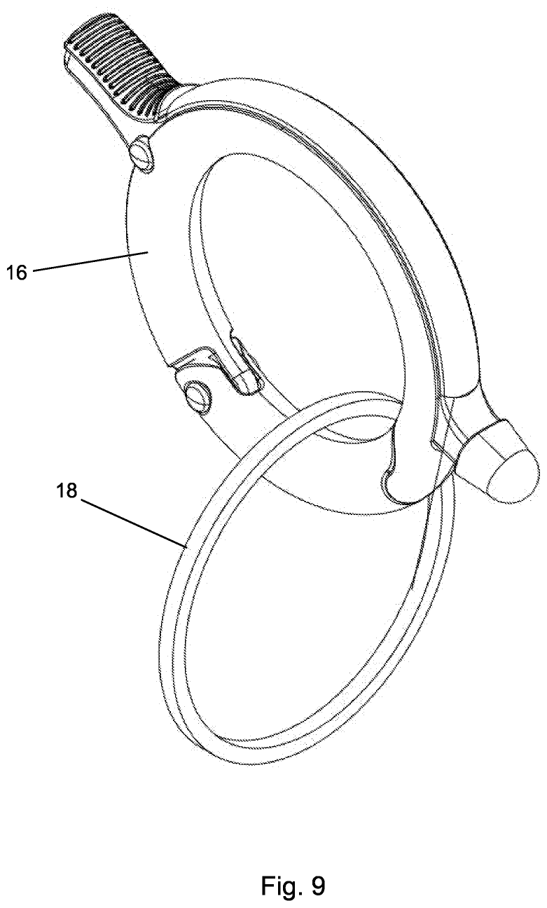

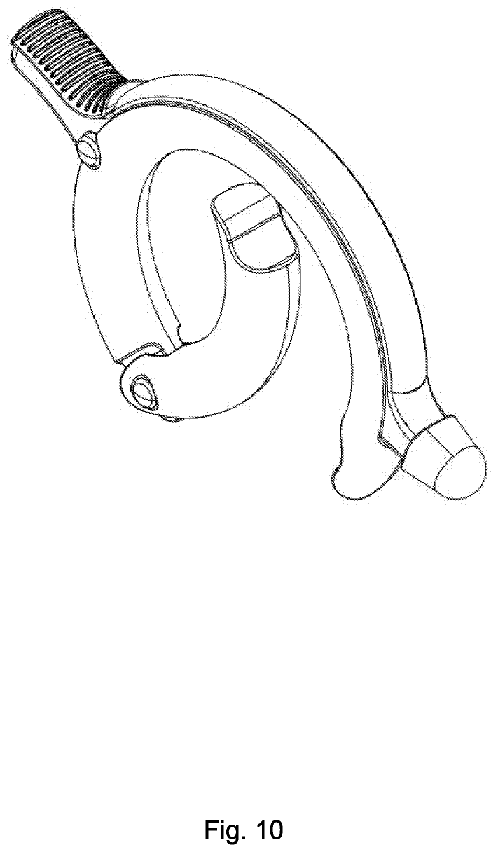

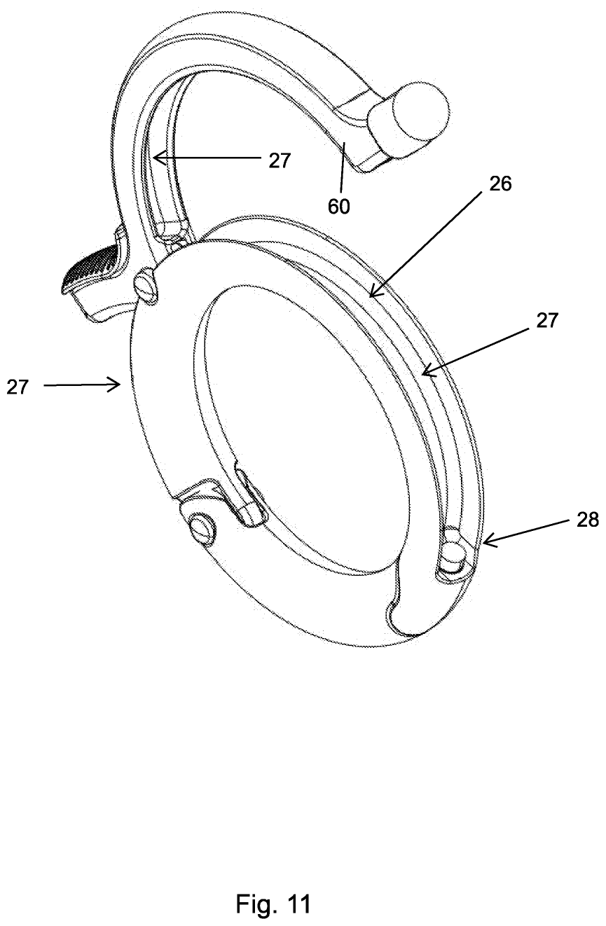

With reference to figures, and particularly FIG. 1 through FIG. 22, an alternative embodiment is presented herein. The alternative embodiment, touchless ring system 110 is formed of any suitable size, shape and design and is configured as an easy to use, convenient to access touchless ring. Said another way, alternative embodiment system 110 (or simply “system”) is configured to provide convenient access to an antimicrobial infused device which can quickly snap into a touchless ring position from a keychain and or ring. Furthermore, system 110 can be quickly closed for storage and the like.

In this way, the system 110 provides for regular and convenient access to a touchless ring. In this way, a user will have access to a touchless ring whenever that user has the system 110 and/or has the keychain with them. The keychain can be quickly opened and quickly closed. The integrated touchless ring is easy to access and store within the system 110; maximizing convenience for storage and encouraging use of the system. In the arrangement shown, as one example, system 110 is configured as a key ring and can easily attach to a user's keys and/or other accessories.

Said another way, the key ring system 110 provides an aesthetically pleasing, easy to use touchless ring device. The flexibility of the system not only allows a user to be comfortable—having peace of mind—but also comfortable with an ergonomic handling device for handling daily tasks without coming into direct contact with a plurality of surfaces—and stabilized in the handling of the key chain device—while providing ergonomic support and stability throughout the entire process. At these times, where the spread of disease affects the daily life of humans around the world, a touchless system which aids in the prevention of the spread of disease is more critical than ever.

In the arrangement shown, as one example, touchless key chain system 110 includes a main body 120, an interior clip feature 130, and an extension feature 140, among other components, features, systems, and functions.

Main Body:

In the arrangement shown, as one example, system 110 includes a main body 120. Main body 120 (or “ring”, or “case”, or simply “body”) is formed of any suitable size, shape, and design and is configured as the main portion of the device for the touchless ring, for the handle, for the holster, and for the storage of all the components and features. The case 120 is configured to hold, and in one embodiment, completely conceal the touchless ring, among other components within the primary housing of the main body 120. Furthermore, and said another way, main body 120 is the main interaction system and primary structure of system 110.

In the arrangement shown, as one example, main body 120 is also configured to connect to a keychain and/or key ring 16/18. Additionally, and in the arrangement shown, main body 120 is configured to quickly connect to and/or quickly accept a variety of other devices which can be connected such as a key chain, key ring, keys, car fobs, belt loops, carabiners, lanyards, any combination thereof, and the like.

In the arrangement shown, as one example, the main body 120 is formed in the shape of a ring and generally appears as a circle, when viewed from the side. Furthermore, the ring is rounded so as to form a curved circle and smooth ring. When viewed from the front, the ring is slender. In the arrangement shown, as one example, the ring of the main body 120 is configured to fit within the palm of the hand of a user. However, other sizes for the ring are also contemplated for use, such as a ring that can accommodate the palm of a hand fitting through the interior, and/or to be worn as a bracelet and the like.

A key ring, also known as a key chain, is a commonly known device in the art. Key rings and/or key chains provide organization to and/or a structural system which links a plurality of keychains or other devices capable of being attached to a ring and/or tethered.

In the arrangement shown, as one example, the main body 120, being formed in the shape of a ring, provides for convenience. In this way, a user can always have the touchless ring conveniently at their fingertips and ready because the user will likely have the car keys and/or items operably attached to system 110. Furthermore, in the arrangement shown, as one example, the smooth surface of the ring provides for ease for a user to slide a single finger and/or plurality of fingers within the interior of the ring. This aids a user in gripping the ring and the like.

Furthermore, in the arrangement shown, as one example, system 110 is designed to be handled with a single hand. Two hands are not required for operation. In other words, and in the embodiment shown, whenever the user has their keys and/or keychain, the user will have system 110 with them and ready to use.

In the arrangement shown, as one example, the main body 120 generally takes the same shape and size as a ring which can fit within the palm of the hand of the user. In the arrangement shown, as one example, a circular ring which works as a key chain 16/18 is hereby contemplated for use. However, other forms of main body 120 are hereby contemplated for use. Examples of other forms of a main body 120 includes, but are not limited to, a standalone ring which does not connect to a key chain and/or does not provide access to allow additional rings to be connected thereto—wherein the standalone ring may be a square shape, an elliptical shape, a spherical shape, and the like—the main body 120 may also be in the shape so as to attach to a to-go coffee mug and/or to go water bottle, a tablet, a smart watch, a watch, a wrist band, and other items, and the like.

Additionally, and in the arrangement shown, as one example, main body 120 is formed of a unitary construction. However, other constructions, such as a dual piece construction with snap fittings are hereby contemplated for use, along with other constructions and connections such as hinged connects, and more. In this way, a user can place their device within the main body 120 and snap the two pieces together, three pieces together, four pieces together, five pieces together, six pieces together, or more, to enclose the device. This construction means and more are hereby contemplated for use.

Additionally, and in the arrangement shown, as one example, main body 120 is formed of a metal material. The metal material is rigid but provides for some flexibility. Other materials are also hereby contemplated for use such as polymers, enhanced polymers, metals, brass, copper, silver, gold, other metal alloys, carbon fiber, polyvinyl chloride, any combination thereof, and the like. In this way, materials can provide decorative and functional purposes from waterproofing to appearance and durability, and the like. Additionally, and in this way, design can be enhanced for appearance and functionality. These types of appearance changes are hereby contemplated for use which may aid in functionality. In the arrangement shown, as one example, the main body 20 is formed of an antimicrobial material and/or infused with an antimicrobial material so as to repel and/or prevent and/or kill infectious diseases.

In the arrangement shown, as one example, the main body 120 has an exterior surface 122, an interior surface 124, opposing curved sides 125, a hollow interior 126, a plurality of cavities 127, a plurality of holsters 128, and a plurality of attachment features 129, among other components, features, and the like.

Holster: In the arrangement shown, as one example, main body 120 includes a plurality of cavities 127. One of the plurality of cavities 127 is at least one holster 136. Holster 136 (or “insert”, or “pocket”, or “receptacle”, or “touchless ring pocket”) is formed from the opposing sidewalls of the main body 120. Holster 128, is a hollow portion of the main body 120 which provides enough space for the slender touchless ring to slide in and out of—and in the arrangement shown, as one example, fit within close and tight tolerances of the hollow interior portion of the holster 128. In addition, the holster 128 may include an attachment feature 129.

Attachment feature: In the arrangement shown, as one example, the holster 136 includes an attachment feature 129. Attachment feature 129 is formed of any suitable size, shape and design and is configured to attach the touchless ring to the main body 120 in a way that the touchless ring is easily accessible. In the arrangement shown, as one example, the attachment feature 129 is formed of a pin which allows the touchless ring to rotate in and out of the holster 128. In this way, the attachment feature provides a stable rotation of the touchless ring so that the touchless ring can be easily rotated out of the holster 128, used for the touchless ring purpose, and then easily rotated back into the interior of the holster 128.

In the arrangement shown, as one example, holster 128 includes an attachment feature 129 which is formed of a pin and a rotationally allowable connection or plurality of connections. However, other attachment means are hereby contemplated for use. Other attachment means may include, but are not limited to, snap features, frictional fit, hinged connections, a combination thereof, and the like. Additionally, a unitary construction is also hereby contemplated for use for an attachment means.

Interior Clip:

In the arrangement shown, as one example, system 110 includes an interior clip 130. Interior clip 130 (or “Access door”, or “access clip”, or opener valve“, or simply “clip”) is formed of any suitable size, shape, and design and is configured to act as a gate allowing access to the interior of the main body 120. Said another way, and in the arrangement shown, the interior clip 30 is configured to rotate open and spring shut when opening is not needed. In this way, and in the example shown, a second ring or key chain, or key ring can easily be attached and secured into place with the main body 120 by means of the interior clip 130.

In the arrangement shown, as one example, the interior clip 130 is semicircular in shape and completes a portion of the circle which makes up the construction of the main body 120. In the arrangement shown, as one example, the interior clip 130 is formed of the same material as the main body 120. However, the interior clip 130 may also be formed of a different material than the main body 120.

In the arrangement shown, as one example, the interior clip 130 extends from a first end 132—where the interior clip 130 is connected to the main body 120—to a second end 134. Like the main body 120, the interior clip 130 has an interior surface 136, which faces toward the interior portion of the ring. The interior clip 130 also includes an exterior surface 137.

Additionally, and in the arrangement shown, as one example, the interior clip 130 includes at least one attachment feature 138. Attachment feature 138 is formed of any suitable size, shape and design and is configured to attach the interior clip 130 to the main body 120 in a way that the interior and ring functionality of the system is easily accessible. In the arrangement shown, as one example, the attachment feature 138 of the interior clip 130 is formed of a pin which allows the interior clip 130 to rotate in and out of the interior of the main body 120. In this way, the attachment feature provides a stable rotation of the interior clip 130.

In the arrangement shown, as one example, the interior clip 130 also includes a second end which has a clasp feature 139. Clasp feature 139 is formed of any suitable size shape and design and is configured to lock and/or clasp the interior clip 130 in place with the main body 120. In this way, the clasp feature 139 can also lock in place. These and other features, are hereby contemplated for use, among other functionality, and features.

Extension Feature:

In the arrangement shown, as one example, the system 110 includes an extension feature 140. Extension feature 140 (or “extension ring feature”, or “extension”, “or “touchless ring” or simply “tool”) is formed of any suitable size, shape, and design and is configured as an extension arm which folds out of the main body and/or which extends from one of the plurality of cavities of the main body 120.

In the arrangement shown, as one example, extension feature 140 extends from a first end 142 to a second end 144 having an interior surface 46 and an exterior surface 148. The touchless ring and/or extension feature 140 which extends from the main body 120 much like the shape of the finger of a human finger or curved structure in a way that enables the user to engage with surfaces like a user would engage surface with the touch of a finger tip and or hand which commonly is used to interact with surfaces.

Additionally, and in the arrangement shown, as one example, the extension feature 140 includes an attachment feature 150, a clasp feature 152, a control knob 154, a stylus 156, a stylus pad 158, and a grab feature 160.

In the arrangement shown, as one example, the extension feature 140 includes at least one attachment feature 150. Attachment feature 150 is formed of any suitable size, shape and design and is configured to attach the extension feature 140 to the main body 120 in a way that the extension feature and ring functionality of the system is easily accessible. In the arrangement shown, as one example, the attachment feature 150 of the extension feature 140 is formed of a pin which allows the extension feature 140 to rotate in and out of the interior of the main body 120. In this way, the attachment feature provides a stable rotation of the extension feature 140.

In the arrangement shown, as one example, extension feature 140 includes a grab feature 160. Grab feature 160 is formed of any suitable size, shape, and design and is configured to allow a user to pull an item directly toward them and/or in a direction. In the arrangement shown, as one example, the grab feature 160 extends from the main body 120 when the extension feature 140 is engaged.

In the arrangement shown, as one example, the extension feature 140 extends from the grab feature at approximately 90 degrees, at the base of the extension feature 140. However, other angles for optimized physics are hereby contemplated for use. Other angles include, but are not limited to, an extension angle of 90 degrees, 0-5 degrees, 5-15 degrees, 15-25 degrees, 25-35 degrees, 35-45 degrees, 45-55 degrees, an incline angle of 55-60 degrees, an incline angle of 60-65 degrees, an incline angle of 65-70 degrees, an incline angle of 80-85 degrees, an incline angle of 85-90 degrees, and the like. Other side to side angles of orientation are also hereby contemplated for use.

Additionally, and in the arrangement shown as one example, the touchless ring includes a single extension touch feature and a single grab feature. However, other numbers of touch features and grab features are hereby contemplated for users. Other numbers of touch features may include a single touch feature, two touch features, three touch features, four touch features, or more. Other numbers of grab features may include a single grab feature, two grab features, three grab features, and more grab features.

Additionally, and in the arrangement shown extension feature 140 is formed of a metal material. The metal material is rigid but provides for some flexibility. Other materials are also hereby contemplated for use such as polymers, enhanced polymers, metals, brass, copper, silver, gold, other metal alloys, carbon fiber, polyvinyl chloride, any combination thereof, and the like. In this way, materials can provide decorative and functional purposes from waterproofing to appearance and durability, and the like. Additionally, and in this way, design can be enhanced for appearance and functionality. These type of appearance changes are hereby contemplated for use which may aid in functionality. In the arrangement shown, as one example, the extension feature 40 is formed of an antimicrobial material and/or infused with an antimicrobial material so as to repel and/or prevent and/or kill infectious diseases.

Extension Control Feature:

In the arrangement shown, as one example, system 110 includes an extension control feature 121 (also known as “lever”). Extension control feature 121 or lever 121 is formed of any suitable size, shape, and design and is configured to act as a lever and/or button type of mechanism, which when pressed extends the extension feature (to be further discussed herein). In this way, the lever 121 can be used. Furthermore, in this way a user need not ever touch the extension feature 140. This means a user will not need to touch the surface of the system 110 which has interacted with other surfaces.

In other words, a user can extend the extension control feature 140 away from and/or out of the holser 128 without actually contacting the extension feature 140. In this way, or in the opposite direction, the extension control feature 170 can also be used to retract and/or store the extension feature 140.

Antimicrobial Infused System: In the arrangement shown, as one example, system 110 is formed of an antimicrobial material 180. Antimicrobial material 180 may be formed of any suitable mixture, contents, and/or formula and is formed of an antimicrobial infusement. In this way, the material 180 which makes up system 110 is infused with an agent that kills microorganisms and/or stops microorganism growth. Furthermore, in this way, the infused silicone prevents bacterial growth and/or other growth that leads to unhealthy use and/or the spread of infectious disease.

In the arrangement shown, as one example, the infusion of brass acts as an antimicrobial agent. However, other antimicrobial agents are hereby contemplated for use. Other antimicrobial agents, include, but are not limited to, antibiotics, antifungals, penicillin, aminoglycosides, ofloxacin, erythromycin, tetracycline, chloramphenicol, gold, copper, other metals, a combination thereof, and the like.

Additional Features:

In the arrangement shown, as one example, a plurality of additional features are also hereby contemplated for use.

Bottle Opener:

In an alternative embodiment, the main body 120 may include a bottle opener. Bottle opener is formed of any suitable size, shape, and design and is configured to open bottles and/or other bottles through a prying motion. Bottle openers are well known in the art and are hereby contemplated for use for integration into the system in the main body 120 and/or the extension feature 140.

Locking Mechanism:

In an alternative embodiment, the main body 120 and/or the extension feature 140 may include a locking mechanism.

In Operation:

As one example, and in the arrangement shown, a personal case mobile system within an integrated touchless ring is shown. The disclosure herein also considers methods of using these systems and features.

It will be appreciated by those skilled in the art that other various modifications could be made to the device without parting from the spirit and scope of this disclosure. All such modifications and changes fall within the scope of the claims and are intended to be covered thereby.

What is claimed:

1. A touchless keyring system, comprising:
a main body;
the main body extending a length from a first end to a second end;
the main body having an exterior surface;
an interior clip;
the interior clip extending a length from a first end to a second end;
the interior clip having an exterior surface;
an extension feature;
the extension feature extending a length from a first end to a second end;
the extension feature having an exterior surface;
the extension feature having a grab feature;
wherein the grab feature is operably connected to the main body;
wherein the grab feature is configured to be stored within a hollow interior of the main body;
wherein the grab feature is operably connected to the main body such that the grab feature rotates into a stored position when the grab feature is stored within the hollow interior of the main body;
wherein the grab feature is operably connected to the main body such that the grab feature rotates into an open position when the grab feature is extended from the main body.

2. The system of claim 1, further comprising:
the main body having a clasp feature.

3. The system of claim 1, further comprising:
the main body having a clasp feature;
the interior clip having an attachment feature;
wherein the attachment feature of the interior clip operably connects the interior clip to the main body;
the interior clip having a clasp feature;
wherein the interior clip includes a spring loaded connection such that the clasp feature of the interior clip is caused to be engaged with the clasp feature of the main body when the interior clip is engaged in a closed position.

4. The system of claim 1, further comprising:
the interior clip having an attachment feature;
wherein the attachment feature of the interior clip operably connects the interior clip to the main body;
the interior clip having a clasp feature;
wherein the interior clip includes a spring loaded connection such that the clasp feature of the interior clip is caused to be engaged with the main body when the interior clip is engaged in a closed position.

5. The system of claim 1, further comprising:
the extension feature having an attachment feature;
the extension feature having a clasp feature.

6. The system of claim 1, further comprising:
the extension feature having a control knob.

7. The system of claim 1, further comprising:
the extension feature having a stylus.

8. The system of claim 1, further comprising:
the extension feature having a stylus;
wherein the stylus of the extension feature is a stylus pad.

9. The system of claim 1, further comprising:
an antimicrobial;
wherein the materials of the system are infused with the antimicrobial.

10. The system of claim 1, further comprising:
an antimicrobial;
wherein the exterior surface of the main body is coated with the antimicrobial;
wherein the exterior surface of the interior clip is coated with the antimicrobial;
wherein the exterior surface of the extension feature is coated with the antimicrobial;
wherein the exterior surface of the extension control feature is coated with the antimicrobial.

11. The system of claim 1, further comprising:
a bottle opener.

12. The system of claim 1, further comprising:
a holster container.

13. The system of claim 1, further comprising:
a storage cover.

14. A touchless keyring system, comprising:
a main body;
the main body extending a length from a first end to a second end;
the main body having an exterior surface;
the main body having a clasp feature;
an interior clip;
the interior clip extending a length from a first end to a second end;
the interior clip having an exterior surface;
the interior clip having an attachment feature;
wherein the attachment feature of the interior clip operably connects the interior clip to the main body;
the interior clip having a clasp feature;
wherein the interior clip includes a spring loaded connection such that the clasp feature of the interior clip is caused to be engaged with the clasp feature of the main body when the interior clip is engaged in a closed position;
an extension feature;
the extension feature extending a length from a first end to a second end;
the extension feature having an exterior surface;
the extension feature having an attachment feature;
the extension feature having a grab feature;
wherein the grab feature is operably connected to the main body;
wherein the grab feature is configured to be stored within a hollow interior of the main body;
wherein the grab feature is operably connected to the main body such that the grab feature rotates into a stored position when the grab feature is stored within the hollow interior of the main body;
wherein the grab feature is operably connected to the main body such that the grab feature rotates into an open position when the grab feature is extended from the main body;
an extension control feature;
the extension control feature extending a length from a first end to a second end;
the extension control feature having an exterior surface;
the extension control feature having an attachment feature;
wherein the attachment feature of the extension control feature securely attaches the extension control feature to the main body;
the extension control feature having a grip mechanism;
wherein the grip mechanism enables enhanced control and stabilization for a user.

15. The system of claim 14, further comprising:
the extension feature having a stylus;
wherein the stylus provides for touchscreen control.

16. The system of claim 14, further comprising:
an antimicrobial;
wherein the exterior surface of the main body is coated with the antimicrobial;
wherein the exterior surface of the interior clip is coated with the antimicrobial;
wherein the exterior surface of the extension feature is coated with the antimicrobial;
wherein the exterior surface of the extension control feature is coated with the antimicrobial.

17. The system of claim 14, further comprising:
a bottle opener.

18. The system of claim 14, further comprising:
a locking clasp;
a storage cover.

19. The system of claim 14, further comprising:
wherein the extension control feature is operably connected to the main body such that the extension control feature rotates into a closed position when the extension control feature is stored within the hollow interior of the main body;
wherein the extension control feature is operably connected to the main body such that the extension control feature rotates into an open position when the extension control feature is extended from the main body.

20. A method of touching a feature using a touchless keyring system, comprising the steps:
providing a touchless keyring system; the touchless keyring system having a main body and an extension feature and a control feature of the main body;
holding the main body and maneuvering the touchless keyring system with the control feature;
extending the extension feature;
applying force to an object without directly touching the object, using the touchless keyring system.
